(19) United States
(12) Patent Application Publication
(10) Pub. No.: US 2025/0087008 A1
(43) Pub. Date: Mar. 13, 2025

(54) Document Converter

(71) Applicant: Duquesne University of the Holy Spirit, Pittsburgh, PA (US)

(72) Inventor: Patrick Juola, Pittsburgh, PA (US)

(73) Assignee: Duquesne University of the Holy Spirit, Pittsburgh, PA (US)

(21) Appl. No.: 18/826,379

(22) Filed: Sep. 6, 2024

Related U.S. Application Data
(60) Provisional application No. 63/537,252, filed on Sep. 8, 2023.

(51) Int. Cl. G06V 30/41

(52) U.S. Cl. CPC G06V 30/41

(57) ABSTRACT

The instant document converter transforms any text or text-predominant document, virtually immediately and automatically, to a list containing solely its culled, formatted references, together with one or more coordinated executables that launch the culled formatted references as a search query, when triggered, to a search engine for verification analysis.

### FIELD OF THE INVENTION

The invention pertains to a manipulation and conversion of an electronic document, to prepare the document for authenticity analysis, specifically, as to whether it has likely been generated largely or completely by AI (artificial intelligence).

### INTRODUCTION

Despite its positive attributes, one difficulty with AI is knowing when AI has authored a text and, by extension, whether the veracity of some or all of that text might be spurious. With a global explosion of AI generated text, it is already urgent to be able to distinguish AI-originated text from human-authored text. This general need, in turn, virtually demands that such a technology be automated. The present invention seeks to meet this challenge by converting an electronic document, at the outset, so that in its converted form the text is then ripe for further specific analysis of the document to distinguish its likely authorship type. While document analyses of various types are already known, the present technology—directed to converting the text in question, followed by further analysis—is the key to the present invention.

### SUMMARY OF THE INVENTION

In order to facilitate analysis of a text or electronic document as to its authorship source (human versus AI) the present invention comprises, initially, a document converter. The instant document converter can convert any text or text-predominant document, virtually immediately and automatically, to a list containing its culled, cited references, furthermore with said cited references' being formatted in such a way as automatically to create—and run—an effective search statement in one or more search engines, to identify any one or more citations, if any, as spurious or nonexistent. The presence of one or more questionable citations in a document is a “flag” as to the possible authorship of the document by an AI source—even if the document has already been edited by a human author as to its overall grammar and style. Another way to characterize this technology, then, is “document verifier,” meaning a way to verify that a given text contains no spurious or nonexistent citations (verified text).

### DETAILED DESCRIPTION OF THE INVENTION

The present document converter operates by taking an electronic text—or text-predominant electronic document—and converting it according to the following automated steps. First, the text or text-predominant portion is verified, by the present technology, as OCR (optical character recognition) enabled, providing OCR processing if necessary. (OCR enabling may not be necessary if the document is already in an appropriate format, and similarly may involve a different conversion. E.g., an HTML document does not need to be “OCRed” but does need to be de-formatted, similarly for a Word document.) Second, the instant technology identifies most or all of the references in the document and renders them as a culled list, at a minimum separating each citation (and more typically each citation field) by the Boolean operator, “OR” and with possible additional formatting discussed further below. Third, by coordinating code instructions with the citation list, the current technology automatically submits the citation list entries to a search engine and/or technical database, such as without limitation PubMed or Google Scholar. (Normally code and data are kept separate—for example, the list of citations might be in an Excel file, and a separate program would read the file and submit each item/line separately to the search engine.) For example, the query: Binongo “who wrote the 15th book of Oz?” finds a single reference: Binongo, J. N. G. (2003). Who wrote the 15th book of Oz? An application of multivariate analysis to authorship attribution, Chance, 16 (2), 9-17. By contrast, the query: binongo “who wrote Return of the King?” finds no citations, because such a publication does not exist. Fourth, the technology renders as an output to a user the results of analysis of the citations—either to verify the citations as correct or to flag possible inaccuracies in the citations. The inventive technology is therefore the initial conversion of the document, in a concrete way, in which the converted document then drives (due to its format and contained one or more executables) its own further search engine analysis for veracity. In other words, the present document converter does not merely extract and format citations found in a given text or passage of text—the present document converter renders the citations as a search query and also includes the necessary code to execute the automated searching of the culled and formatted citation list by one or more search engines.

By way of background and explanation, one of the key issues with automatic writing systems, such as ChatGPT and other Large Language Models (LLMs), is that they have a tendency (so to speak) to “hallucinate” and to create bogus references (see for example Weiser, B. (2023) “Here's what happens when your lawyer uses ChatGPT” New York Times, May 27, 2023). This erstwhile “hallucination” can include (without limitation) generating creatively fictional citations to nonexistent prior publications. By checking a document to determine whether some or all of the cited references actually exist, the present technology can flag potentially AI-drafted texts (evidenced by spurious citations therein) even if such texts have already been edited to attempt to disguise the original text's AI-generated style. After all, busy students, journalists, and writers of all type—including but not limited to disinformation agents—can be tempted by AI text generation and the time it saves (despite its notorious absence of adequate fact checking and the aforesaid fanciful generation of citations). As a hindsight understanding fueled by the present invention, one can appreciate that human conducted style-editing of standard text is relatively easy compared to laborious research validation of individual citations. A human editor's cosmetic editing of an AI-generated text will thus generally fail to erase the AI-generated inaccuracies in one or more unreliable citations. By extension, however, this also means that if a human author carefully edits an AI-generated text to the point of correcting all the citations—and ostensibly fact-checking everything else about the text in the process—the character of the text as predominantly AI-generated will have mostly if not completely been mooted. As a result, the present invention is not only useful to identify texts that have been generated by AI but also to identify texts that have been largely or completely generated by AI and have not subsequently been edited and corrected by human intervention. In other words, the presence of significant anomalies in included citations is a good indication that an AI-generated text is still largely (or completely) AI-generated and concomitantly unverified. By extension, too, if the present tool is used by a human author to vet—and concomitantly to correct—citations in an AI-generated text, the present document converter is not only an AI-detector but is also a tool for analyzing and improving an AI-generated text, when AI generation is wielded as a responsible drafting tool, not as an unethical short-cut.

Because, as described above, the individual verification of each cited reference can be an untenably time-consuming task, the present technology importantly converts the document to be reviewed to a culled list of its cited references, into a standard format with the references' citations' fields being separated (at a minimum) by the Boolean operator OR. By “culled list” is not meant that certain citations would be omitted—instead, the “culling” here is to remove from the list text BESIDES citations, with citation fields, to create a comprehensive “compiled” or culled citation list from the document being analyzed As described above, the culled list is also provided with an executable command to search one or more search engines as to the culled citation list. Such a converted document, with its culled citation list and the OR operator (plus other optional Boolean and/or database or “separated value” formatting described further below) and its included executable, then becomes a readily analyzable search statement for virtually any search engine, which in turn can determine whether each citation exists at all or is partially accurate. Triggering the search statement in a search engine is well known in the art—there are programs such as “Curl” that will execute a web query from the command line—and a technology which both culls a citation list AND executes a search statement is believed not to have been conceived of, or implemented, prior to the present invention. For example, any modern programming language can open a web page, and if the web page the user opens is a search engine, then it will execute the user's query. For example, in Python, the command is “from urllib.request import urlopen page=urlopen (“https:/www.example.com”)” If the page chosen is (e.g.) google.com, and if the user passes in the correct language, it will return the same results that a web query would, and string a page from which the user can extract the desired information. So, if the user opens scholar.google.com, then the technology will drive a specific search of scholarly literature. The point here is that the present technology, as a document converter, takes text, assures OCR, culls and formats a citation list and includes adequate code automatically to trigger at least one search engine search of the citation list as a search query, with collection of the results of the search as an output to a user.

With regard to the exact formatting of the compilation of citations that populate the query, the present technology can drive this in lots of ways, depending on how strict the user wants to be with regard to false positives and false negatives. For example, if someone cites (*Juola, Patrick. (2003). “Something really cool.”) and it turns out that it was actually published in 2004 instead of 2003, one might conclude that this is maybe just a typographic error in the citation, and not necessarily a flag that the text was generated by AI. If there were a paper with that same title as a published article, but with a different author, the citation might simply have been a good-faith mistake. But—if the only thing that matches is the date, this match indicates, or flags, a likely problem with the citation as a whole. Similarly, if the search engine finds (Juola, P. (2003). “Something really awesome.”) then that's a kind-of (noisy) match that a user can decide is spurious or not. And by “the user,” of course, is meant the technology overall, because the technology “can take” all kinds of these decisions and even apply a machine learning system to infer the best way to distinguish noisy citations from nonexistent ones (yes, AI can be helpful in flagging texts that are generated by AI).

With regard to the composition or formatting of the query, then, there are lots of choices beyond separating each citation field with a Boolean “OR” to start with, including but not limited to: (1) ALL of the fields per citation have to match (using ANDs); (2) AT LEAST ONE of the fields per citation has to match (using ORs); (3) AT LEAST k (for some chosen constant k) of the fields have to match; or (4) THE MOST IMPORTANT of the fields have to match (weighted voting with predefined weights). Existing programs or applications such as Scholarcy can be helpful for reference extraction, and “regular expression” citation extraction is well within the skill of the art at this writing. Given this disclosure, those of ordinary skill in the art will immediately appreciate the fine points of creating the converted document (including its one or more executables) for further analysis, according to the invention. As mentioned above, the technology embraces specific machine learning to determine the best way of combining and applying queries and results. The invention thus embraces machine extraction of citations with subsequently added command(s) to run at least one search engine query to vet those citations. Accordingly, the invention constitutes the initial document conversion to cull the citations contained in the document-to create a culled citation list in a form suitable for further search engine analysis-AND the addition of one or more executables to drive the automated search, and to return a result which either verifies or “flags” each citation.

The following illustration is exemplary and not limited. For example (from libguides.wpi.edu), a citation of a single-author book in APA format looks like this: Brader, T. (2006). Campaigning for hearts and minds: How emotional appeals in political ads work. University of Chicago Press. The citation format can thus be generalized as: Author's Last name, First Initial. (Year). Book title: Subtitle. (Edition) [if other than the 1st]. Publisher. As illustrated here, periods are used to separate the fields so the culled citation list in turn allows the elements in the citations to be read further as period separate values. The invention, then, embraces the conversion of the document to the desired citation list and formatting thereof. For a print article, APA format dictates, Last name, First Initial. (Year, Month Day). Article title. Magazine/Journal/Newspaper Title, Volume number (Issue number), Page numbers of the entire article. Such a citation format would be accommodated differently, in the subsequent analysis of the citations, but document conversion according to the invention optimally would conform all citations to the same style and format.

Interestingly, the present document conversion lends itself to subsequent document analysis by traditional search engines but NOT by software or applications that themselves generate AI-authored text, such as ChatGPT or others. In other words, the citations lists in converted documents (with executables) created by the present document conversion technology need to be vetted by search engines with generally established and reliable fact content, not by entities that might invent citations and thus ostensibly verify spurious document-contained citations against equally spurious invented bibliographies.

As described above, therefore, the entire start-to-finish technology disclosed herein embraces all of the following modules in aggregated and virtually or completely automated form: a) OCR verification; b) citation extraction and formatting; b) accessing the internet to run a query or queries to confirm veracity (or lack thereof) of each citation; d) interpreting query results; and e) generating an output to a user to identify any “veracity lacking” flags. As to step d), interpreting the query results embraces the above-described multi-faceted citations' vetting to match author names with article titles, journals with dates, and various permutations thereof. As to all of a) through e), various individual portions of the technology disclosed herein have been used in other contexts, but to the inventor's knowledge the synthesis of document converting for citation evaluation to determine AI authorship (or not) has heretofore never been conceived or achieved, to solve the present document-provenance challenge.

Although the invention has been described herein as to particular methods and hardware, the invention is only to be limited insofar as is set forth in the accompanying claim.

I claim:

1. An electronic document converter application for vetting all or a portion of an electronic text document suspected of having been generated by AI, comprising: a) an OCR module to verify or to add optical character recognition to said electronic text document; b) a citation culling module to extract citations from said electronic text document; c) a citation formatting module to insert one or more Boolean operators to said citations to create formatted citations; d) an executable, added by codification in cooperation with said formatted citations, which when triggered automatically searches a search engine using said formatted citations as the search query; and e) an output to a user identifying whether said formatted citations contain correct citations according to said search engine.

2. The electronic document converter application according to claim 1, wherein said user is a machine learning system that distinguishes a noisy citation from a nonexistent citation.

3. The electronic document converter application according to claim 2, wherein said modules, said executable, said output and said machine learning system all operate sequentially and by automation to cull a citation list and executes a search statement comprising said citation list in a standard search engine, together with collecting the results of a search performed by said search statement.

4. The electronic document converter application according to claim 3 wherein, as a result of the automated, sequential steps, confirms whether said electronic text document is verified.
